(19) United States
(12) Patent Application Publication
(10) Pub. No.: US 2009/0265637 A1
(43) Pub. Date: Oct. 22, 2009

(54) METHOD AND APPARATUS FOR PROVIDING SERVICE AND METHOD AND APPARATUS FOR CONTROLLING TERMINAL

(75) Inventors: Seung-ho Lee, Busan (KR); Jae-hwan Kim, Busan (KR); Bong-seok Park, Busan (KR); Yu-sung Kim, Busan (KR)

Correspondence Address: MCNEELY BODENDORF LLP, P.O. BOX 34175, WASHINGTON, DC, 20043, US

(73) Assignee: Samsung Electronics Co., Ltd., Suwon-si (KR)

(21) Appl. No.: 12/267,802

(22) Filed: Nov. 10, 2008

(30) Foreign Application Priority Data
Apr. 17, 2008 (KR) 2008-35820

(51) Int. Cl. G06F 3/048; G06F 15/16; G06F 17/30

(52) U.S. Cl. 715/738; 709/203; 715/847; 707/10; 715/769

(57) ABSTRACT

A method and apparatus for providing a widget service. The method includes receiving a user request signal to request that a service provided in a first space using a widget application be provided in a second space; receiving information for providing the service in the second space from an external server in response to the user request signal, the information for providing the service including information regarding at least one widget application; and providing the service in the second space based on the received information, wherein one of the first and second spaces is a first web page displayed on the display unit, and the other of the first and second spaces is a second web page displayed on the display unit or a background screen of a terminal.

### CROSS-REFERENCE TO RELATED APPLICATION

This application claims the benefit of Korean Patent Application No. 2008-35820, filed in the Korean Intellectual Property Office on Apr. 17, 2008, the disclosure of which is incorporated herein by reference.

### BACKGROUND OF THE INVENTION

1. Field of the Invention

Aspects of the present invention relate to a method and apparatus for providing a service and a method and apparatus to control a terminal providing the service, and more particularly, to a method and apparatus to provide a widget service, and a method and apparatus to control a terminal providing the widget service.

2. Description of the Related Art

A widget refers to an application having low memory or processing capacity that performs a specific function. A computer operating system (OS) operates the widget and displays an image on a computer screen in the form of a graphic user interface (GUI). Widgets are classified into desktop widgets and web widgets according to where a service is provided.

Although web widgets are provided by a specific website through a web browser and are less influenced by the OS, if the web browser is closed, the web widgets cannot provide a service. Desktop widgets are provided on a background screen. If the user downloads a widget application and installs the widget application in a desktop, it is possible to use widgets on the background screen. Desktop widgets may provide services based on information received via the Internet, such as news, weather, etc., or provide services that do not require the Internet, such as clocks, calendars, electronic calculators, etc.

Owing to the rapid increase in Internet culture, a blog service that is referred to as individual media has recently gained popularity. Blogs include an online diary where entries are commonly displayed in reverse chronological order. Blogs allow free uploading of diaries, columns, news, etc., according to a user's interests, and can provide various services, such as personal publishing, personal broadcasting, community, etc. Users who are not satisfied with only diaries uploaded on blogs would like to provide various services such as news, weather, scheduling, etc. These users frequently use widget applications in order to provide such additional services.

However, a web widget, which provides services on blogs, can be used only when users access a corresponding website through a web browser. Therefore, users need to access the corresponding website through the web browser in order to use services provided by the web widget. In particular, since the web widget provides services on a specific website, a background screen or another web page cannot provide the same services as provided by the web widget.

Similarly, user terminals in which a widget is installed can use services provided by a desktop widget. If users change computers or use services provided by the widget by using another computer, it is inconvenient to have to access a corresponding website through a web browser and download the widget. In addition, the desktop widget cannot be used in the website, which limits types of available widgets. As described above, widget applications have spatial limitation, which causes inconvenience for the user.

### SUMMARY OF THE INVENTION

Aspects of the present invention provide a method and apparatus to provide a widget service without spatial limitation and a method and apparatus for controlling a terminal.

According to an aspect of the present invention, a method of providing a service in a terminal including a display unit is provided. The method comprises receiving a user request signal to request that a service provided in a first space using a widget application be provided in a second space; receiving information for providing the service in the second space from an external server in response to the user request signal, the information for providing the service including information regarding at least one widget application; and providing the service in the second space based on the received information, wherein one of the first and second spaces is a first web page displayed on the display unit, and the other of the first and second space is a second web page displayed on the display unit or a background screen of a terminal.

According to another aspect of the present invention, the user request signal is a signal generated by clicking a predetermined part of a display window providing the service of the first space and dragging the predetermined part to the second space.

According to another aspect of the present invention, the method further comprises if the user request signal is received, transmitting a request message to the external server; wherein the request message includes at least one of an identifier of the widget application providing the service, information regarding a user requesting the service to be provided in the second space, and information regarding a location in the second space corresponding to the user request signal.

According to another aspect of the present invention, the external server provides a web service via communication with a client, and the information includes a result of executing the at least one widget application obtained by the external server via the web service.

According to another aspect of the present invention, the method further comprises synchronizing the content of the service provided in the first space and the content of the service provided in the second space.

According to another aspect of the present invention, the method further comprises generating an icon corresponding to the service in the second space; and if the icon is selected, providing the service in the second space.

According to another aspect of the present invention, a method of providing a service in a terminal including a display unit is provided. The method comprises receiving a request message including at least one of information regarding a user that requests that a service provided in a first space using a widget application be provided in a second space, an identifier of the widget application providing the service, and information regarding a location in the second space to which the service is to be provided, from the terminal; obtaining information for providing the service in the second space based on the request message; and transmitting the information for providing the service to the terminal, wherein one of the first and second spaces is a first web page displayed on the display means, and the other of the first and second spaces is a second web page displayed on the display unit or a background screen of a terminal.

According to another aspect of the present invention, the method further comprises renewing a database in which at least one of information regarding at least one widget application, information regarding at least one registered user, and information regarding a widget application that is provided to the at least one user, are recorded based on the request message.

According to another aspect of the present invention, the obtaining of the information for providing the service comprises providing a web service via communication with a client, and the information for providing the service includes a execution result of the widget application obtained by the external server via the web service.

According to another aspect of the present invention, the method further comprises synchronizing the content of the service provided in the first space and the content of the service provided in the second space.

According to another aspect of the present invention, a method of providing a service in a terminal including a display unit is provided. The method comprises receiving a drag and drop signal to drag a display window displaying a service that is provided in a first space using a widget application and to drop the display window to a second space; and displaying the display window displaying the service on a location in the second space corresponding to the drag and drop signal, wherein one of the first and second spaces is a first web page displayed on the display unit, and the other of the first and second spaces is a second web page displayed on the display unit or a background screen of the terminal.

According to another aspect of the present invention, an apparatus to provide a service in a terminal including a display unit is provided. The apparatus comprises a signal receiving unit to receive a user request signal requesting that a service provided in a first space using a widget application be provided in a second space; an information receiving unit to receive information for providing the service in the second space from an external server in response to the user request signal, the information for providing the service including information regarding at least one widget application; and a controller to control the service to be provided in the second space based on the received information, wherein one of the first and second spaces is a first web page displayed on the display unit, and the other of the first and second spaces is a second web page displayed on the display unit or a background screen of a terminal.

According to another aspect of the present invention, an apparatus to provide a service in a terminal including a display unit is provided. The apparatus comprises a message receiving unit to receive a request message including at least one of information regarding a user requesting that a service provided in a first space using a widget application be provided in a second space, an identifier of the widget application providing the service, and information regarding a location in the second space to which the service is to be provided, from the terminal; an information obtaining unit to obtain information for providing the service in the second space based on the request message; and a transmitting unit to transmit the information for providing the service to the terminal, wherein one of the first and second spaces is a first web page displayed on the display unit, and the other of the first and second spaces is a second web page displayed on the display unit or a background screen of a terminal.

According to another aspect of the present invention, an apparatus to provide a service in a terminal including a display unit is provided. The apparatus comprises a signal receiving unit to receive a drag and drop signal to drag a display window displaying a service that is provided in a first space using a widget application and to drop the display window to a second space; and a controller to control the display window displaying the service to be displayed on a location in the second space corresponding to the drag and drop signal, wherein one of the first and second spaces is a first web page displayed on the display unit, and the other of the first and second spaces is a second web page displayed on the display unit or a background screen of a terminal.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a system for providing a service according to an embodiment of the present invention;

FIG. 2 illustrates data communication between a user PC and a web server shown in FIG. 1;

FIG. 3 illustrates a system for operating a web service according to an embodiment of the present invention;

FIG. 4 illustrates the system for providing the service shown in FIG. 1 in more detail;

FIG. 5 illustrates an apparatus for providing a service according to an embodiment of the present invention;

FIG. 6 illustrates a display unit included in the apparatus for providing the service shown in FIG. 5;

FIG. 7 illustrates an apparatus for controlling a terminal according to an embodiment of the present invention;

FIG. 8 is a flowchart of a process of controlling a terminal according to an embodiment of the present invention;

FIG. 9 is a flowchart of a process of providing a service according to an embodiment of the present invention;

FIG. 10 is a flowchart of a process of controlling a terminal according to another embodiment of the present invention;

FIG. 11 is a dataflow diagram of a system for providing a service according to an embodiment of the present invention; and

FIG. 12 is a flowchart of a process of providing a service according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

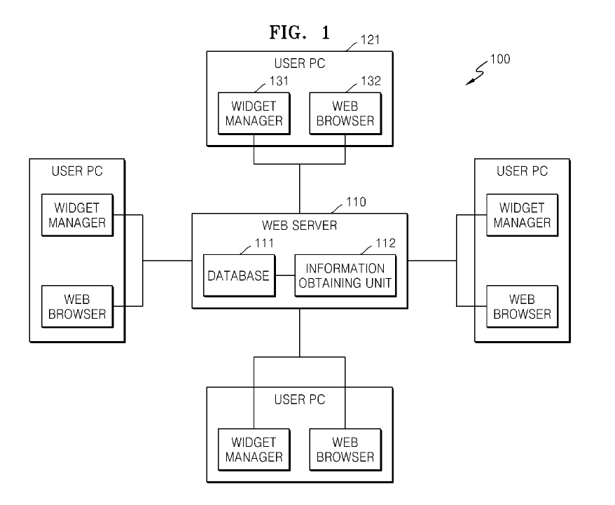

FIG. 1 shows a system 100 to provide a service according to an embodiment of the present invention. A plurality of user PCs 121-124 are connected to a web server 110, and receive the service using a widget application. Since the operation of each user PC is similar, hereinafter the operation of the system 100 for providing the service will now be described in view of the user PC 121. The user PC may be any device capable of using a widget application, such as a desktop computer, portable computer, mobile telephone, personal digital assistant (PDA), personal entertainment device, or other mobile or fixed computing device.

The user PC 121 comprises a web browser 132 that provides the service using the widget application on a web page and a widget manager 131 that provides the service by using the widget application on a background screen. For convenience of description, the service provided using the widget application will be referred to as a widget service.

The widget manager 131 can download the widget application from a specific web page and install the widget application in the user PC 121. The widget manager 131 manages a desktop widget by, for example, moving, deleting, and adding the widget. The widget manager 131 registers the widget in an icon format on a widget toolbar on the background screen of the user PC 121 in order to easily identify an available widget. Furthermore, the widget manager 131 may employ a drag and drop interface so as to manipulate icons, thereby excluding the widget registered with the widget toolbar, registering a new widget, or automatically arranging icons.

The web server 110 comprises a database 111 and an information obtaining unit 112. The database 111 comprises information regarding at least one widget and information regarding a registered user. The information obtaining unit 112 communicates with the widget manager 131 or the web browser 132, obtains information necessary for providing a widget service, and transfers the information to the user PC 121.

For example, a user wants to receive the widget service, which is provided to the user on a web page, on the background screen. The user clicks a display window in the web page providing the widget service by using a mouse, drags the display window, and drops the display window to the outside of the web page, i.e., the background screen. A user request signal indicating that the user wants to receive the widget on the background screen may be generated.

When the user request signal is generated, the web browser 132 transmits a request message including at least one of an identifier of the widget application providing the widget service, user information, and information regarding a location in the background screen where the display window is moved, to the information obtaining unit 110.

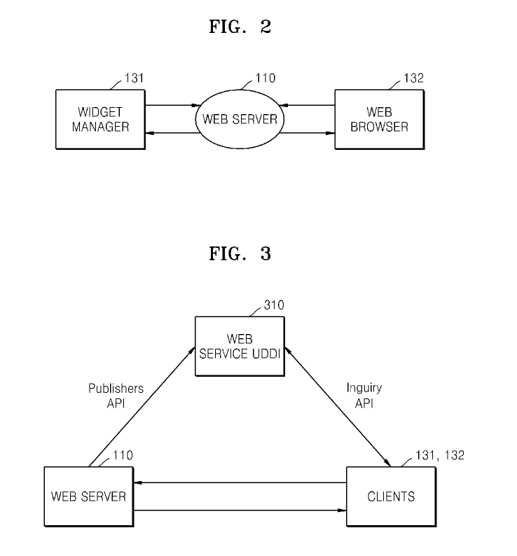

The information obtaining unit 110 uses the request message and information stored in the database 111 to obtain information for providing the widget service on the background screen. The information obtaining unit 112 can use a web service to obtain the information for providing the widget service. The web service will be described in detail later with reference to FIG. 2.

The information obtaining unit 112 transfers the obtained information to the widget manager 131. The information obtaining unit 112 renews user information stored in the database 111. The database 111 can store information on the widget service provided to each user, and renews the information on the widget service that a corresponding user receives from a desktop.

The widget manager 131 uses the information received from the information obtaining unit 112 to provide the widget service on the background screen. Similarly, the widget service that is provided on the background screen can be provided to the user on the web page, or a widget service that is provided on a first web page can be provided to the user on a second web page.

FIG. 2 shows data communication between the user PC 121 and the web server 110 shown in FIG. 1 according to an embodiment of the present invention. The web server 110 provides a web service. The web service uses communication between different applications mounted on heterogeneous platforms to perform a job. In a web service environment, an application of a client, instead of a user, requests data processing in a web service module via a website, and transmits a result of data processed by the web service module. The client can receive the same result value by calling a previously developed web service module without having to develop an application that is not possessed by the client.

Generally, a result value obtained by processing a document or value requested via a web browser in a server is transmitted via the hypertext markup language (HTML) format using the hypertext transfer protocol (HTTP). However, the web service can remotely perform a desired function of any device or program using the simple object access protocol (SOAP). The web service can use a function that is implemented in a remote computer by using the SOAP in the same manner as the web service's own function. The SOAP used by the web service is a protocol in a format of exchanging a message (or an object) between software. The web service can use various communication protocols, such as a service modeling language (SML), HTTP, and a transmission control protocol/Internet protocol (TCP/IP), as extensible distribution protocols. If the user adds an automatic calculation function to a word processor of a personal digital assistant (PDA), the user searches for location information and a specification of a necessary function from a universal description, discovery, and integration (UDDI) registry of the web service and calls an object relating to calculation. Information and services may be provided using other protocols in addition to, or instead of, those described above.

A web provider registers a web service that can be provided by the web provider with the UDDI of the web service so that the web service can be searched for. The widget manager 131 or the web browser 132 searches the UDDI of the web service and calls a desired web service. The widget manager 131 or the web browser 132 transmits information for receiving the web service to the web server 110. The web server 110 processes the information and returns a result value of the processed information to the widget manager 131 or the web browser 132.

FIG. 3 shows a system to operate a web service according to an embodiment of the present invention. The system comprises clients 131 and 132, the web server 110, and a web service UDDI 310. The web service UDDI 310 registers web services provided by a web service provider so that the clients 131 and 132 can search for and call a desired web service.

The web server 110 registers web services with the web service UDDI 310 using a publisher application programming interface (API). The clients 131 and 132 search and call a web service to be provided from the web service UDDI 310 by using an inquiry API. Thereafter, if the clients 131 and 132 transmit data for receiving a web service to the web server 110, the web server 110 returns a result value to the clients 131 and 132 using the called web service and the received data.

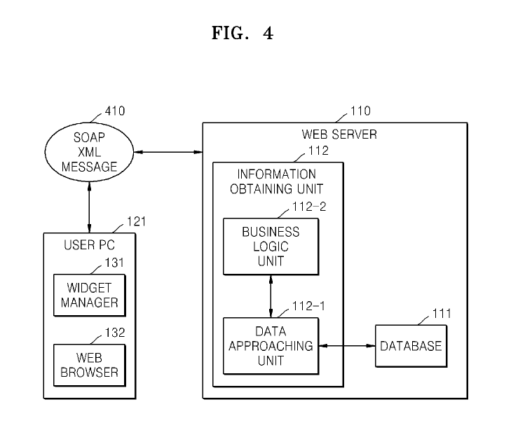

FIG. 4 shows the system 100 in more detail. As shown in FIG. 4, the information obtaining unit 112 may comprise a data approaching unit 112-1 and a business logic unit 112-2. The data approaching unit 112-1 comprises a code used to access data stored in the database 111, and searches the data stored in the database 111. The business logic unit 112-2 processes data in response to requests of clients such as the widget manager 131 and the web browser 132 so that the clients can receive services.

The clients (such as the widget manager 131 and the web browser 132 and the web server 110) communicate with each other via a SOAP message 410. The SOAP message 410 can be delivered using HTTP.

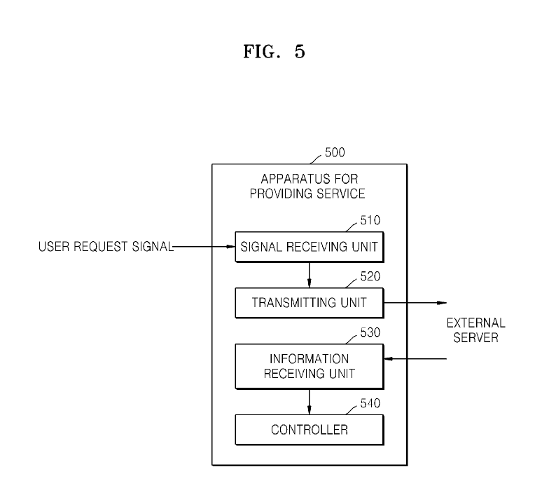

FIG. 5 shows an apparatus 500 to provide a service according to an embodiment of the present invention. The apparatus 500 comprises a signal receiving unit 510, a transmitting unit 520, an information receiving unit 530, and a controller 540. The apparatus 500 may also include a display unit (not shown). The display unit displays logically divided first and second spaces.

The signal receiving unit 510 receives a user request signal requesting that a service provided in the first space using a widget application be provided in the second space. One of the first and second spaces may be a first web page displayed on the display unit. The other may be a second web page displayed on the display unit or a background screen of a user terminal.

The signal receiving unit 510 previously establishes a signal corresponding to the user request signal. For example, the signal receiving unit 510 can establish a signal generated by double-clicking a display window where a widget service is provided or by clicking a predetermined part of the display window and dragging the predetermined part thereof, as the user request signal.

The transmitting unit 520 transmits a request message that requests, from an external server, information for receiving the service in the second space. The request message can comprise at least one of an identifier of the widget application providing the widget service, information regarding a user that requests to provide the widget service in the second space, and information regarding a location in the second space corresponding to the user request signal. The request message need not include all of the above information; for example, the request message may include only an identifier of the widget application, or the request may include the identifier of the widget application and information regarding a location in the second space corresponding to the user request signal. If the external server provides the web service, the request message can be a signal calling a specific web service.

The information receiving unit 530 receives the information for providing the widget service in the second space from the external server in response to the user request signal. The information for providing the widget service may include information regarding at least one widget application. The external server can provide the web service. The information receiving unit 530 can receive a result of executing the widget application obtained by the external server via the web service. The information receiving unit 530 does not directly download the widget application providing the service, but can receive the result of executing the widget application (such as display information for displaying the service on the display unit.)

The controller 540 controls the widget service to be provided in the second space based on the received information. The apparatus 500 may further comprise a synchronizing unit (not shown) and an icon generating unit (not shown).

The user can change the content of the widget service provided in each of the first and second spaces. If the content of the widget service provided in one of the first and second spaces is changed, the synchronizing unit changes the content of the widget service provided in another space to be identical to the changed content of one space, so that the content of the widget services provided in the first and second spaces is synchronized.

The icon generating unit generates an icon corresponding to the widget application providing the service in the second space. Thereafter, if the user selects the icon, the controller 540 displays a widget service provided by the widget application corresponding to the selected icon in the second space.

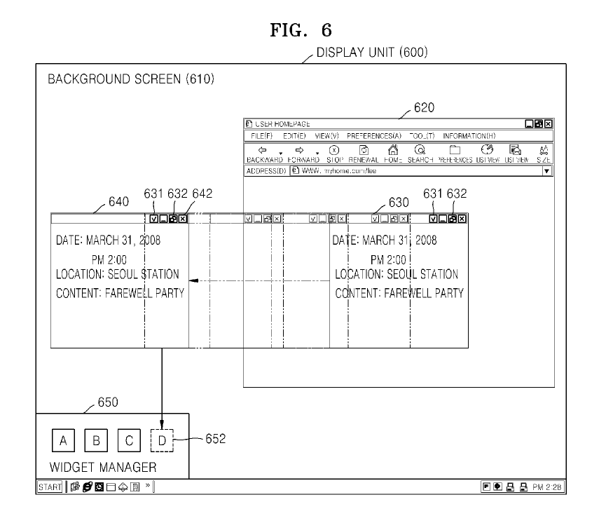

FIG. 6 shows a display unit 600 included in the apparatus 500 according to an embodiment of the present invention. A user accesses his/her own homepage 620 via a web browser. The homepage 620 displays a display window 630 providing an engagement notifying service that is provided through a web widget application.

For descriptive convenience, it is assumed in the example shown in FIG. 6 that a first space is the homepage 620, and a second space is a background screen 610. In addition, the user wants to receive the engagement notifying service on the background screen 610 without accessing the homepage 620. These examples should not, however, be seen as limiting aspects of the present invention.

The display window 630 providing the engagement notifying service includes a predetermined area 631 used to receive a user request signal. For example, when the user double-clicks or clicks the predetermined area 631, drags the predetermined area 631 on the background screen 610, and drops the window, the user request signal is determined to be received. While the user is dragging the display window 630, the display unit 600 can display the display window 630 as being inactivated in order to indicate the movement of the display window 630.

If the display window 640 receives the user request signal, the web browser transmits an identifier of a widget application providing the engagement notifying service and information on the user requesting a movement of widget providing engagement notifying service to an external server.

The widget manager 650 receives information for providing the engagement notifying service on the background screen 610 from the external server, and displays the display window 630 providing the engagement notifying service on the background screen 610 based on the received information. The external server may store information on a widget application provided to each user, and may renew information regarding types of widget applications provided on a background screen belonging to the user requesting the movement of widget providing engagement notifying service. Thereafter, even if the user closes the homepage 620, the widget manager 650 can continuously provide the engagement notifying service on the background screen 610 using the information received from the external server.

If the user clicks a specific area 642 of the display window 640, the display window 630 disappears from the background screen 610, and an icon 652 corresponding to the widget application can be added to a toolbar managed by the widget manager 650. The user selects the icon 652 to continuously receive the engagement notifying service.

The user can change the content of the engagement notifying service provided on the background screen 610. For example, if the user changes an engagement time from 2:00 pm to 3:00 pm, the widget manager 650 transfers such a change to the external server. Since the external server stores information on widget applications provided to each user, the external server changes the entire content of the engagement notifying service provided to a corresponding user. Therefore, when the user accesses the user's own homepage 620 in another terminal, the engagement notifying service reflects the entire content changes.

As described above, a service provided on a web page using a web widget application is provided on a background screen. Similarly, a widget service provided on the background screen using a desktop widget application can be provided on the web page, or a widget service provided on a first web page can be provided on a second web page. Any services provided using the web widget application on the web page controlled by a system according to aspects of the present invention can be provided on another web page or the background screen.

For example, a friend's homepage and a user's homepage are under the control of a system according to aspects of the present invention. A notice board is provided to the friend's homepage and the user's homepage, respectively, using web widget applications. The notice board provided in the friend's homepage is referred to as a friend's notice board, and the notice board provided in the user's homepage is referred to as a user's notice board.

The user accesses the friend's homepage, and moves a display window providing the friend's notice board to the user's homepage. Thereafter, the user can view his/her own notice board and the friend's notice board even though the user accesses his/her own homepage. If another person accesses the friend's homepage, and changes the content of the friend's notice board, the content of the friend's notice board displayed on the user's homepage is accordingly changed.

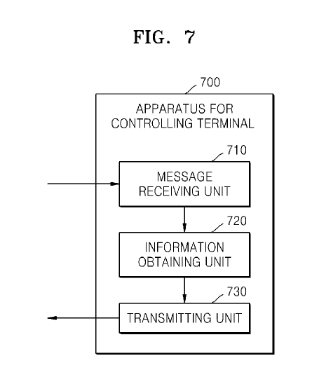

FIG. 7 shows an apparatus 700 to control a terminal according to an embodiment of the present invention. The apparatus 700 comprises a message receiving unit 710, an information obtaining unit 720, and a transmitting unit 730.

The message receiving unit 710 receives a request message from the terminal. The request message comprises at least one of information regarding a user that requests that a service in a first space using a widget application to be provided in a second space, an identifier of the widget application providing the service, and information regarding a location of the background screen to which the service is to be provided. The request message need not include all of the above information; for example, one or more of the above items of information may be omitted from the request message. One of the first and second spaces is a first web page displayed on a display unit. The other of the first and second spaces is a second web page displayed on the display unit or a background screen of the terminal.

The apparatus 700 may further comprise a web service module (not shown) providing a web service by communicating with clients. In this case, the request message can be a signal calling the web service as described above.

The information obtaining unit 720 obtains information for providing the service in the second space based on the request message. The information can include a result of executing a widget application obtained by the web service module via the request message.

The apparatus 700 may further comprise a database (not shown) in which at least one of information regarding at least one widget application, information regarding at least one registered user, and information regarding a widget application that is provided to the at least one user, is recorded, and can renew the data base based on the request message. The database need not store all of the above information; for example, the database may store only information regarding registered users, or may store both the information regarding registered users and the information regarding the widget application. When the apparatus 700 receives a message requesting that the service provided in the first space using the widget application be provided on the background screen, the apparatus 700 renews information regarding types of widget applications provided on a corresponding user's background screen. When the apparatus 700 receives a message requesting that a service provided on a specific user's background by using the widget application to be provided on a first web page, the apparatus 700 renews information regarding types of widget applications provided on the first web page.

The transmitting unit 730 transmits the obtained information to the terminal. The apparatus 700 may further comprise a synchronizing unit (not shown) that synchronizes the content of the service provided in the first space and the content of the service provided in the second space.

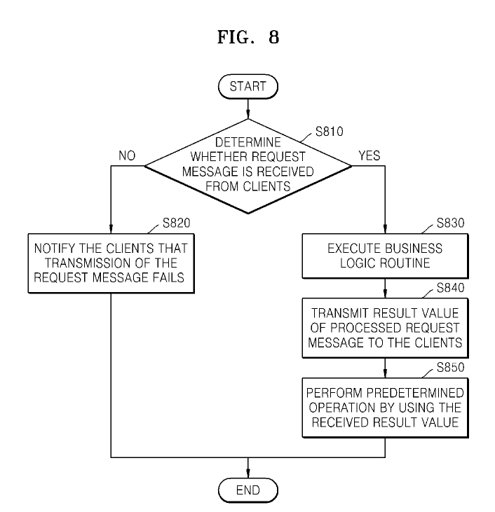

FIG. 8 is a flowchart of a process of controlling a terminal according to an embodiment of the present invention. In operation 810, whether a request message calling a web service (such as a widget manager or a browser) is normally received from a client is determined. If the request message is received from the clients, a business logic routine is executed, and the request message is processed in operation 830. If not, the client is informed that the transmission of the request message has failed in operation 820. In operation 850, the clients perform a predetermined operation using the received result value.

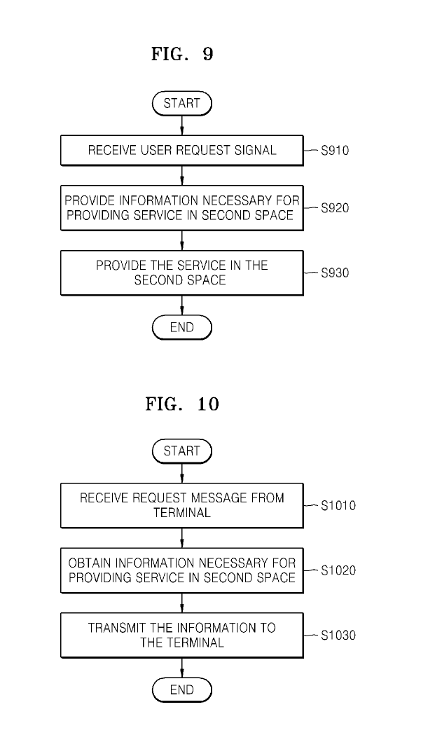

FIG. 9 is a flowchart of a process of providing a service according to an embodiment of the present invention. In operation 910, a user request signal that requests a service provided in a first space using a widget application to be provided in a second space. The user request signal can be a signal generated by clicking a predetermined part of a display window providing the service of the first space and dragging the predetermined part to the second space.

In operation 920, information for providing the service in the second space is received from an external server including information regarding at least one widget application in response to the user request signal. In operation 930, the service is provided in the second space using the received information. One of the first and second spaces may be a first web page displayed on a display unit, and the other may be a second web page displayed on the display unit or a background screen of a terminal.

FIG. 10 is a flowchart of a process of controlling a terminal according to another embodiment of the present invention. In operation 1010, a request message is received from the terminal. The request message comprises at least one of information regarding a user that requests that a service in a first space by using a widget application be provided in a second space, an identifier of the widget application providing the service, and information regarding a location of the background screen to which the service is to be provided.

In operation 1020, information for providing the service in the second space is obtained based on the request message. In operation 1030, the information is transmitted to the terminal.

FIG. 11 is a dataflow diagram of a system to provide a service according to an embodiment of the present invention. In operation 1110, a user request signal requesting that a service provided in a first space using a widget application be provided in a second space is received. In operation 1120, the request message is transmitted to an external server. In operation 1130, information for providing the service in the second space is obtained based on the request message. In operation 1140, the information for providing the service in the second space is received. In operation 1150, the service is provided in the second space based on the received information.

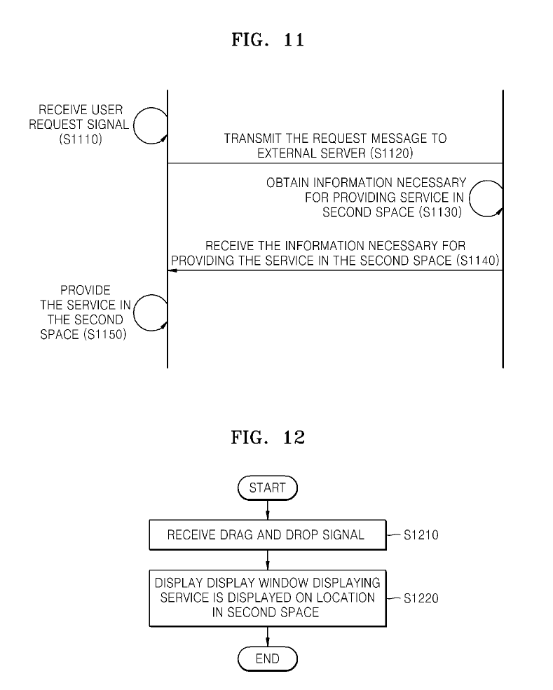

FIG. 12 is a flowchart of a process of providing a service according to another embodiment of the present invention. In operation 1210, a drag and drop signal to drag a display window displaying a service that is provided in a first space using a widget application and to drop the display window to a second space is received. One of the first and second spaces may be a first web page displayed on a display unit, and the other may be a second web page displayed on the display unit or a background screen of a terminal.

In operation 1220, the display window displaying the service is displayed on a location in the second space corresponding to the drag and drop signal. Although information for providing a widget service in the second space can be received via a web service as described above, the web service is only an example. A web widget service that is provided only on a first web page can be provided on a second web page or on a background screen, or information for providing a desktop widget service that is provided on the background screen can be provided on a web page.

Aspects of the present invention can be also embodied as computer readable codes on a computer readable recording medium. The computer readable recording medium is any data storage device that can store data which can be thereafter read by a computer system. Examples of the computer readable recording medium include read-only memory (ROM), random-access memory (RAM), CDs, DVDs, Blu-ray discs, magnetic tapes, floppy disks, and optical data storage devices. Aspects of the present invention may also be embodied as carrier waves (such as data transmission through the Internet).

A web widget and a desktop widget can be freely used without any spatial limitations. If content of a widget service that is used in more than one location, is changed, the content of a widget service that is provided in another space is changed to be identical to the changed content of the one widget service, thereby sharing information. In addition, a web widget used by another person can be provided to a user's desktop or to another web page, thereby sharing a widget application.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of providing a service in a terminal including a display unit, the method comprising:
receiving a user request signal to request that a service provided in a first space using a widget application be provided in a second space;
receiving information for providing the service in the second space from an external server in response to the user request signal, the external server including information regarding at least one widget application; and
providing the service in the second space based on the received information;
wherein one of the first and second spaces is a first web page displayed on the display unit, and the other of the first and second spaces is a second web page displayed on the display unit or a background screen of a terminal.

2. The method of claim 1, wherein the user request signal is a signal generated by clicking a predetermined part of a display window providing the service of the first space and dragging the predetermined part to the second space.

3. The method of claim 1, further comprising:
if the user request signal is received, transmitting a request message to the external server;
wherein the request message includes at least one of an identifier of the widget application providing the service, information regarding a user requesting the service to be provided in the second space, and information regarding a location in the second space corresponding to the user request signal.

4. The method of claim 1, wherein:
the external server provides a web service via communication with a client; and
the information includes a result of executing the at least one widget application obtained by the external server via the web service.

5. The method of claim 1, further comprising:
synchronizing the content of the service provided in the first space and the content of the service provided in the second space.

6. The method of claim 1, further comprising:
generating an icon corresponding to the service in the second space; and
if the icon is selected, providing the service in the second space.

7. A method of providing a service in a terminal including a display unit, the method comprising:
receiving a request message including at least one of information regarding a user that requests that a service provided in a first space using a widget application be provided in a second space, an identifier of the widget application providing the service, and information regarding a location in the second space to which the service is to be provided, from the terminal;
obtaining information for providing the service in the second space based on the request message; and
transmitting the information for providing the service to the terminal;
wherein one of the first and second spaces is a first web page displayed on the display unit, and the other of the first and second spaces is a second web page displayed on the display unit or a background screen of a terminal.

8. The method of claim 7, further comprising:
renewing a database in which at least one of information regarding at least one widget application, information regarding at least one registered user, and information regarding a widget application that is provided to the at least one user, are recorded based on the request message.

9. The method of claim 7, wherein:
the obtaining of information comprises providing a web service via communication with a client; and
the information for providing the service includes a execution result of the widget application obtained by the external server via the web service.

10. The method of claim 7, further comprising:
synchronizing the content of the service provided in the first space and the content of the service provided in the second space.

11. A method of providing a service in a terminal including a display unit, the method comprising:
receiving a drag and drop signal to drag a display window displaying a service that is provided in a first space using a widget application and to drop the display window to a second space; and
displaying the display window displaying the service on a location in the second space corresponding to the drag and drop signal,
wherein one of the first and second spaces is a first web page displayed on the display unit, and the other of the first and second spaces is a second web page displayed on the display unit or a background screen of the terminal.

12. An apparatus to provide a service in a terminal including a display unit, the apparatus comprising:
a signal receiving unit to receive a user request signal requesting that a service provided in a first space using a widget application be provided in a second space;
an information receiving unit to receive information for providing the service in the second space from an external server in response to the user request signal, the external server including information regarding at least one widget application; and
a controller to control the service to be provided in the second space based on the received information,
wherein one of the first and second spaces is a first web page displayed on the display unit, and the other of the first and second spaces is a second web page displayed on the display unit or a background screen of the terminal.

13. The apparatus of claim 12, wherein the user request signal is a signal generated by clicking a predetermined part of a display window providing the service of the first space and dragging the predetermined part to the second space.

14. The apparatus of claim 12, further comprising:
a transmitting unit to transmitting a request message if the user request signal is received, the request message including at least one of an identifier of the widget application providing the service, information regarding a user that requests the service to be provided in the second space, and information regarding a location in the second space corresponding to the user request signal, to the external server.

15. The apparatus of claim 12, wherein:
the external server provides a web service by communicating with the terminal; and
the information includes a result of executing the at least one widget application obtained by the external server via the web service.

16. The apparatus of claim 12, further comprising:
a synchronizing unit to synchronize the content of the service provided in the first space and the content of the service provided in the second space.

17. The apparatus of claim 12, further comprising:
an icon generating unit to generate an icon corresponding to the service in the second space,
wherein the controller, if the icon is selected, provides the service in the second space.

18. An apparatus to provide a service in a terminal including a display unit, the method comprising:
a message receiving unit to receive a request message including at least one of information regarding a user requesting that a service provided in a first space using a widget application be provided in a second space, an identifier of the widget application providing the service, and information regarding a location in the second space to which the service is to be provided, from the terminal;
an information obtaining unit to obtain information for providing the service in the second space based on the request message; and
a transmitting unit to transmit the information for providing the service to the terminal,
wherein one of the first and second spaces is a first web page displayed on the display unit, and the other of the first and second spaces is a second web page displayed on the display unit or a background screen of a terminal.

19. The apparatus of claim 18, further comprising:
a database in which at least one of information regarding at least one widget application, information regarding at least one registered user, and information regarding a widget application that is provided to the at least one user, are recorded; and
a renewing unit to renew the database based on the request message.

20. The apparatus of claim 18, further comprising:
a web service module to provide a web service by communicating with the terminal,
wherein the information includes an execution result of the widget application obtained by the web service module by using the request message.

21. The apparatus of claim 18, further comprising:
a synchronizing unit to synchronize the content of the service provided in the first space and the content of the service provided in the second space.

22. An apparatus to provide a service in a terminal including a display unit, the apparatus comprising:
a signal receiving unit to receive a drag and drop signal to drag a display window displaying a service that is provided in a first space using a widget application and to drop the display window to a second space; and
a controller to control the display window displaying the service to be displayed on a location in the second space corresponding to the drag and drop signal;
wherein one of the first and second spaces is a first web page displayed on the display unit, and the other of the first and second spaces is a second web page displayed on the display unit or a background screen of a terminal.

23. A computer-readable recording medium having embodied thereon a program to execute the method of claim 1.
